(19) United States
(12) Patent Application Publication
(10) Pub. No.: US 2023/0188547 A1
(43) Pub. Date: Jun. 15, 2023

(54) SYSTEM AND METHOD FOR NETWORK SECURITY

(71) Applicant: Sigil Cyber Analytics LLC, Manassas, VA (US)

(72) Inventors: Thomas F. Moore, Chantilly, VA (US); Stephen B. Jones, Manassas, VA (US)

(73) Assignee: Sigil Cyber Analytics LLC, Manassas, VA (US)

(21) Appl. No.: 17/546,944

(22) Filed: Dec. 9, 2021

(51) Int. Cl. H04L 9/40; H04L 41/28

(52) U.S. Cl. CPC H04L 63/1425; H04L 41/28

(57) ABSTRACT

A monitoring application is configured to model access events in which elements of a network access a network asset. The monitoring application can receive inputs to identify elements that are authorized to access a particular asset, and can define a trust zone including such authorized elements, including the asset. The monitoring application receives log data from which it identifies access events, including the identities of elements involved in each access events. For access events in which sources that are not part of a trust zone access an asset that is part of the trust zone, the monitoring application can generate a trust zone violation alert prompting IT staff to determine whether network security has been breached, whether the network security architecture should be modified, or whether the model should be updated.

### BACKGROUND

The present disclosure relates to the field of computer network security, and more particularly in identifying threats to and weaknesses in a network security system.

Computer networks include important and valuable assets, such as confidential data. Organizations are well-advised to take steps to prevent bad actors from gaining access to such assets. Traditionally, networks have used perimeter-based defensive approaches, in which credentials are required to gain access to a network and/or particular assets within the network. Perimeter-based defensive approaches and other preventative controls are intended to keep bad actors from accessing a system. However, despite use of such preventative controls, catastrophic cyber attacks on computer networks continue, and confidential data is stolen.

Traditional perimeter-based defensive approaches and preventative security controls have been exposed as poorly-adapted to protecting information technology (IT) architectures that support resources hosted on the cloud and which must support users accessing data remotely and from untrusted network locations and untrusted devices.

The cybersecurity industry is moving toward a so-called “zero trust” security model in which even users and systems that have gained access through perimeter security are still not implicitly trusted. In theory, a zero trust security architecture places sensitive data into microsegments, and access to the microsegments is only granted to authorized users from authorized places and under specified circumstances.

For most organizations, transitioning from a perimeter-based security architecture to a zero trust security architecture is strikingly difficult, and some suspect that strict zero trust is unrealistic. Decisions must be made and implemented to identify users and systems that may or may not access particular data and to establish and maintain rules concerning such access, as well as to enforce such rules. Some tools employ algorithms and machine learning in an attempt to monitor and enforce such rules. However, organizations struggle to establish zero trust architecture that is not rife with inconsistencies, holes, and inefficiencies, many of which the organization is not aware of, and likely may not become aware of until after a catastrophic breach.

### SUMMARY

The present disclosure discusses aspects and tools for modeling and monitoring access events in a network so as to enhance security and aid implementation of zero trust principles. A monitoring application can receive indexed log data and identify access paths by which sources access assets via services. IT staff can identify which network elements, such as sources, services and assets, are authorized to access one another, and a trust zone can be defined about groups of elements so authorized. The access paths identified by the monitoring application can represent actual network traffic and access events resulting from real-time use of the network, rather than relying on testing data. When the monitoring application detects access paths that cross borders of a trust zone, a trust zone violation alert can be generated, prompting further investigation by the IT staff. A trust zone violation may indicate a flaw in the model, and the trust zone defined in the monitoring application may be modified to update the model so as to give IT staff a more accurate view of access traffic within the network security system. A trust zone violation can also highlight a vulnerability in the security architecture, so that resolving or buttressing the security architecture leads to resolving the trust zone violation. A trust zone violation can further identify an actual breach of the system, leading to early intervention efforts to minimize losses and prevent further breaches.

In accordance with one embodiment, the present specification presents a system for modeling and monitoring a network security architecture. A monitoring application is configured to receive log data from a plurality of network elements, the plurality of network elements comprising a plurality of sources, a plurality of services and a plurality of assets. The monitoring application can receive input identifying a trusted group of sources that are to be authorized to access a first asset and to receive input identifying a group of at least one trusted service that is to be authorized to access the first asset. The monitoring application also can define a trust zone that includes the trusted group of sources, the trusted service and the first asset. The monitoring application is configured to analyze the log data to identify an access event wherein a first source of the plurality of sources and a first service of the plurality of services accessed the first asset. The first source is part of the trusted group of sources and the first service is part of the group of at least one trusted services The monitoring application can generate a trust zone violation alert if the first source is not part of the trusted group of sources or if the first service is not part of the group of at least one trusted services.

In some embodiments the log data comprises indexed log data indexed by a security information event management system (SIEM). The monitoring application can be configured with no direct access to the plurality of network elements.

In further embodiments the monitoring application is configured to direct a visual depiction of the trust zone showing the trusted group of sources, group of at least one trusted services, and first asset within the trust zone. The monitoring application can be configured so that when the access event has been identified, an access path is generated visually linking the first source to the first service and the first asset.

The monitoring application can be configured to identify a second source by analyzing the log data, wherein the second source is not included in the plurality of network elements. The second source can also be added to the group of trusted sources.

In accordance with another embodiment, the present specification describes a method of modeling and monitoring a network access security architecture, comprising identifying a plurality of network elements, the plurality of network elements comprising a plurality of sources, a plurality of services and a plurality of assets. A trusted group of the plurality of network elements can be identified, the trusted group being expected to participate with one another in authorized access events in which elements from the trusted group access a first asset. A trust zone can be defined, including the trusted group of the plurality of network elements in the trust zone with the first asset. Log data identifying access event data concerning the plurality of network elements can be received. The log data can be analyzed to identify an access event in which the first asset was accessed by a first source using a first service. It can be determined whether the first source and first service are in the trusted group.

Some embodiments can additionally comprise generating a trust zone violation alert if the first source and first service are not in the trusted group. Further embodiments can generate an access path based on the log data, the access path tying the first source and the first service to the first asset.

### BRIEF DESCRIPTION OF THE DRAWINGS

FIG. 1 is a schematic view of an embodiment of a computer network;

FIG. 2 is a partial view of an embodiment of a screen shot of a monitoring application;

FIG. 2A is a close up view of a portion of the screen shot of FIG. 2;

FIG. 3 is a partial view of another screen shot showing a dashboard of a monitoring application;

FIG. 3A is a view of a screen shot showing an access path highlighted for requiring further review; and

FIG. 4 is a partial view of another screen shot showing a trust zone incorporating element from within and outside of a network.

### DESCRIPTION

The present disclosure discusses tools for modeling and monitoring network traffic in a manner that facilitates a transition toward a zero trust architecture, including a partial transition wherein legacy network structures that are inconsistent with zero trust are maintained, while some principles of zero trust security architecture are also used. A monitoring application can receive indexed log data and identify access paths by which sources access assets via services. These access paths can be depicted visually so that a user can visualize how access traffic proceeds through the network. Such visualization can help IT staff determine which sources are to be expected to have an authorized need to access particular assets. The monitoring application can define a trust zone, which is a construct grouping elements that are expected to have authorized communication and data access events. The trust zone construct exists in the monitoring application, and is not saved in or imposed on the actual elements. Instead, at the direction of IT staff, controls can be installed on elements such as at various endpoints, but independent of the monitoring application. The access paths identified by the monitoring application represent actual network traffic and access events resulting from real-time use of the network, rather than relying on testing data. When the monitoring application detects access paths that cross borders of a trust zone, a trust zone violation alert can be generated, prompting further investigation by the IT staff. A trust zone violation may indicate a flaw in the model, and the trust zone defined in the monitoring application may be modified to update the model so as to give IT staff a more accurate view of access traffic within the network security system. A trust zone violation can also highlight a vulnerability in the security architecture, so that resolving or buttressing the security architecture leads to resolving the trust zone violation. A trust zone violation can further identify an actual breach of the system, leading to early intervention efforts to minimize losses and prevent further breaches.

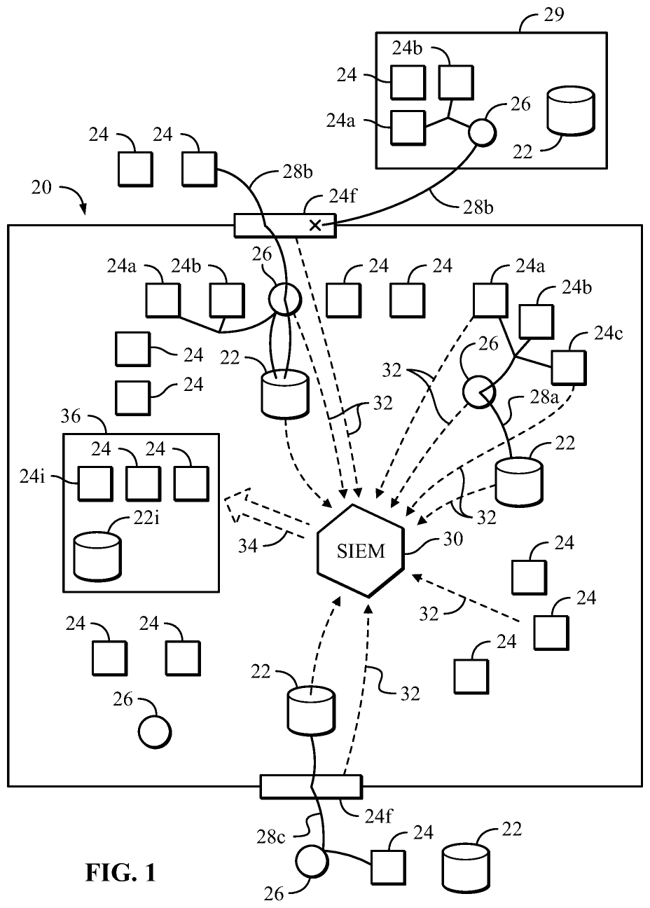

With initial reference to FIG. 1, a computer network 20 is depicted schematically. The illustrated network 20 includes a plurality of network elements, which can include assets 22, sources 24 and services 26. Assets 22 can be, for example, an important application or data store. Sources 24 can refer broadly to entities from which an asset 22 is accessed, and can include a variety of components and data structures, including, for example, user credentials 24a, computers/host machines 24b, routers and interfaces 24d, and firewalls 24f. Services 26 include methods of remotely accessing an asset 22. Generally, services 26 can include network communication transfer protocols such as, for example, web protocol, secure shell protocol (ssh), and server message block protocol (SMB).

Sources 24 access and obtain data from assets 22 via services 26. In FIG. 1, such access is depicted as access paths 28 schematically showing how some sources 24, assets 22 and services 26 are linked. For example access path 28a illustrates a user having credential 24a working from host computer 24b communicating through a router 24c via service 26 to access data store 22.

As depicted in FIG. 1, there are sources 24, services 26, and even assets 22, that are outside the network 20. And there can even be external networks 29 that can feature their own sources 24, services 26 and assets 22. Although these elements are not within the network 20, access between in-network features and out-of-network features can sometimes be allowed. For example, some access paths 28b, 28c, 28d originate from outside the network 20. Access paths 28b and 28c allow access to assets 22 from outside the network 20 via firewalls 24f. Access path 28d depicts an attempt to access in-network assets 22 by sources 24 and services 26 from the external network 29, which attempt reaches the firewall 24f, but is blocked by the firewall 24f.

A zero trust security model aims to restrict access to particular assets 22 and services 26 only to specifically authorized sources 24 and under approved circumstances. Thus, the network 20 can be anticipated to include control applications and strategies, such as endpoint detection/response, network access control, and cloud access security tools, in order to limit access in order to achieve zero trust goals. However, some commonly-used legacy networking equipment and configurations, such as shared hardware infrastructure, central management of enterprise patching/monitoring, and centralized application deployment structures, can be incompatible with a strict zero trust model. Thus, even if an organization wishes to move toward goals of zero trust architecture, it may be impractical to achieve a true zero trust architecture. Many networks 20 thus employ some zero trust principles, but may not fully implement strict zero trust architecture. Still, in an effort to achieve some zero trust goals, the illustrated network 20 can be expected to practice at least some zero trust principles in order to protect assets 22 that have been identified as meriting protection. To that end, information technology (IT) personnel, after identifying such assets 22, can map authorized routes to access such assets 22 and define micro-perimeters about such assets 22. Various tools, such as software agents installed on individual endpoints, such as source host machines 24, database hardware of assets 22, and the like, can attempt to enforce and control access within the defined micro-perimeters. However, it can be difficult when setting up such controls to identify potential holes in the design and/or weak spots that may arise during implementation. Also, monitoring performance of such access controls can be difficult unless IT staff have access to the micro-perimeter. However, of course, the more access granted to the micro-perimeter, the less secure that micro-perimeter is, and granting broad access to IT staff for monitoring performance significantly decreases security controls.

With continued reference to FIG. 1, a centralized logging platform, such as a Security Information Event Management system (SIEM) 30 can receive and analyze security and access event data from logs transmitted 32 to the SIEM 30 from the myriad of assets 22, sources 24 and services 26. Such log transmissions 32 can include streams of chronologically arranged messages generated by applications, network devices, operating systems and any programmable or smart device. They can be referred to as log events, audit trail records, or even just logs.

The SIEM 30 collects the myriad log transmissions 32 and analyzes the logs. Preferably, the SIEM 30 identifies events by indexing the log data. For example, from the logs, the SIEM 30 can identify that host machine 24b had received user credentials 24a, and requested access to asset 22. Log data from router 24c shows that router 24c communicated the request from host machine 24b and that service 26 executed the communication, which was received by asset 22. The SIEM 30 drawing such connections between the log data received from individual features and organizing such data is referred to as indexing the log data. Indexed log data 34 can be communicated by the SIEM 30 to an IT security subnetwork 36, which can save the indexed log data as a data store in an asset 22i. A SIEM 30 configured to index such log data can be obtained from vendors such as Splunk, SolarWinds or McAfee.

A zero trust monitoring application can be stored in asset 22i and accessible to sources 24i within the IT security subnetwork 36. The monitoring application is configured to use indexed log data 34 to map access events so as to help IT staff monitor and evaluate the network's compliance with zero trust principles and to identify possible security breaches.

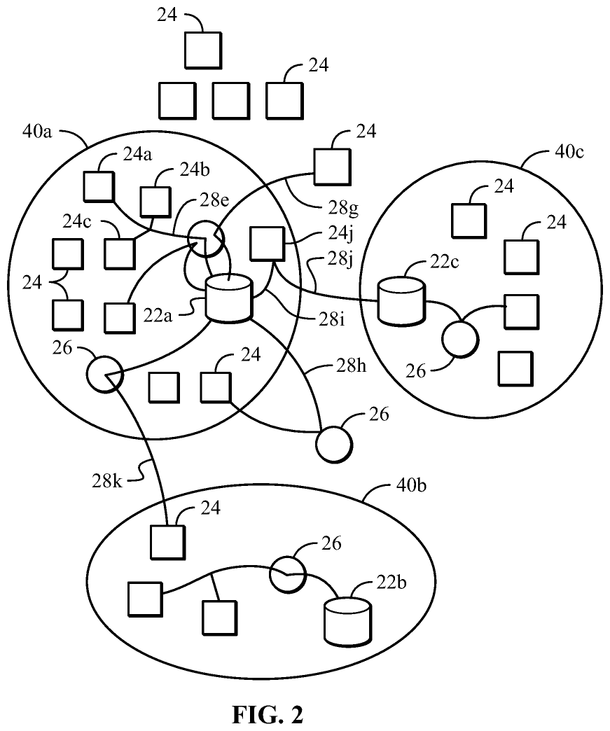

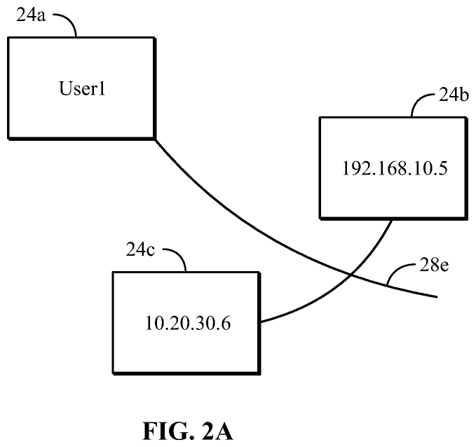

With reference next to FIG. 2, a portion of an example screen shot of the monitoring application is depicted. The monitoring application is configured so that a user can query the STEM 30 to identify the assets 22, sources 24 and services 26 of the network 20. These elements can be visually depicted on the screen using icons as shown in FIG. 2. To set up the monitoring application, the user first identifies the ways that important assets 22 are being accessed on the network 20, and identifies groups of elements that can be expected to appropriately access such assets 22. The monitoring application is configured to create a trust zone 40, which is a logical perimeter that exists in the application. The user then adds one or more assets 22 to the trust zone 40, as well as the group of other elements that have been identified as being expected to appropriately access such assets 22. In a preferred embodiment, such additions can be made visually on screen, such as by dragging icons corresponding to elements and dropping them into a trust zone 40.

Notably, a micro-perimeter that is set up in typical zero trust architecture is defined and installed at the device level (i.e., at endpoints), and typically is configured to control access at that device level. In contrast, a trust zone 40 as discussed herein is defined in the monitoring application, and does not control or directly affect device operation. Instead, the trust zone 40 is a construct used by the monitoring application for modeling and monitoring purposes. It can be understood, however, that in some instances a trust zone 40 may have a scope that resembles a micro-perimeter corresponding to the same asset 22 and associated elements 24, 26.

With continued reference to FIG. 2, once a trust zone 40 is defined in the monitoring application, the user can add elements such as specific assets 22, sources 24 and services 26 that are intended to be trusted in providing communication and access. It is anticipated that networks 20 will have a plurality of trust zones 40, each including a unique grouping of elements that are intended and expected to provide authorized access and communication one with another. In this manner, trust zones 40 provide the user with a visual indication of the organization and scope of the network's security architecture. In fact, the monitoring application develops a model of the network security architecture, which model allows IT staff to visually monitor performance of such architecture.

Once set up, the monitoring application can monitor and visually depict access events, or security events, that occur on the network 20. As discussed above, the STEM 30 provides indexed log data 34 to the IT security subnetwork 36. Preferably, such indexed log data 34 is organized sufficiently that the multiple elements involved in any access event can be identified and grouped together. With continued reference to FIG. 2, the monitoring application can be configured to use the indexed log data 34 to identify access events and the elements involved therein. The monitoring application then creates and visually depicts access paths 28 corresponding to such access events. For example, access path 28e depicts an access event in which a user credential 24a using a laptop 24b attained access to an asset 22 via a router 24c using network protocol service 30. This access event access path 28e is wholly contained within the associated trust zone 40a. Thus, it is anticipated that such access event is expected and appropriate. Similarly, access path 28f depicts another access event wholly contained within trust zone 40a. In such instances, an indicator, such as a green color applied to the depicted access path 28e, 28f, can serve as a quick visual cue signaling the user of the monitoring application that there are no concerns with the access event.

If a user wishes to have more information about the elements depicted on the screen, the user can click on a portion of the screen to zoom in and see additional information. For example, with reference to FIG. 2A, clicking on access path 28e brings sources 24a, 24b and 24c into closer view, and presents identifying information about these sources. For example, source 24a is a credential for “User1”,source 24b is a host computer having the IP address 192.168.10.5, and source 24c is a router having the IP address 10.20.30.6.

It is expected that the monitoring application will identify irregularities. For example, continuing with reference to FIG. 2, access path 28g depicts an access event in which a source 24 that is not assigned to any trust zone accesses asset 22a via service 26, both of which are within the trust zone 40a. As the access path 28g crosses the border of trust zone 40a, the monitoring application identifies this access event as a trust zone violation. The access path 28g can be marked with a visual indicator, such as being depicted in a red color, to provide a visual cue to the IT staff user of a problem to address. At this point, the user may investigate the access event to determine whether access was inappropriate, suggesting a breach to the network 20, or whether access was in fact appropriate, suggesting that the trust zone model should be updated. For example, upon further investigation the user may determine that the source 24 associated with access path 28g should be included in trust zone 40a, and can update the model appropriately. Also, the user may generate a work order to ensure that any micro-perimeter be updated to include the added source. Similarly, access path 28h depicts an access event in which a source 24 within trust zone 40a accesses asset 22, also within trust zone 40a, but via service 26 outside of the trust zone 40a. Upon further investigation, it is determined that the service 26 should be moved into trust zone 40a. Further, access path 28k depicts an access event spanning across multiple zones 40a, 40b which, upon further investigation, can indicate that the associated source 24 was mistakenly assigned to the wrong trust zone upon application setup. In this manner, the monitoring application is configured to use actual access events to update its own accuracy. As can be expected, initial efforts to map and model a network can be expected to have errors and omissions. Since the monitoring application monitors real access events that actually occur on the network, such errors and omissions can be expected to be identified and highlighted during actual use of the network, without necessarily relying on model testing.

Some trust zone violations may expose weaknesses and vulnerabilities within the network security architecture. For example, access path 28i depicts a conforming access event of asset 22a by source 24j, which are both included within trust zone 40a. However, access path 28j depicts a trust zone violating access event in which source 24j accesses asset 22c, which is in trust zone 40c. The trust zone violation triggers further investigation, and it is determined that assets 22a and 22c share the same hardware, for example they may be located on the same server. Source 24j refers to an administrator who is authorized to access asset 22a, but not asset 22c. However, since these assets 22a, 22c share the same hardware device, this situation violates strict zero trust goals, and comprises a weakness or potential vulnerability in network security. Upon evaluating the issue, the IT security group may remove the asset 22c from the shared hardware platform and give it its own hardware platform, to which administrator 24j will have no access. The vulnerability highlighted by the monitoring application will be resolved, and the trust zone violation will be resolved. Alternatively, upon evaluating the risk versus the cost of moving off of a shared hardware platform, the IT security group may determine that it would be appropriate for the administrator source 24j to also have access to asset 22c, and thus source 24j could be added to trust zone 40c to resolve the trust zone violation.

Although it is to be expected that some trust zone violations highlight updates necessary to the monitoring model or depict weaknesses in the security architecture, in some instances trust zone violations can identify breaches. For example, access path 28k may depict a source 24 in trust zone 40b, which may be a trust zone directed to accounting-type information, and the associated source 24 may be a computer assigned to an accountant employee. However, trust zone 40a may be dedicated to a confidential engineering project, and access of the asset 22 in trust zone 40a by the source 24 in trust zone 40b indicates a potentially serious breach. The IT staff user of the monitoring application then can direct implementation of security breach protocols, such as immediate investigation of the offending source 24 and user credential, and initiating immediate access control blocking the offending source 24, as well as a forensic analysis.

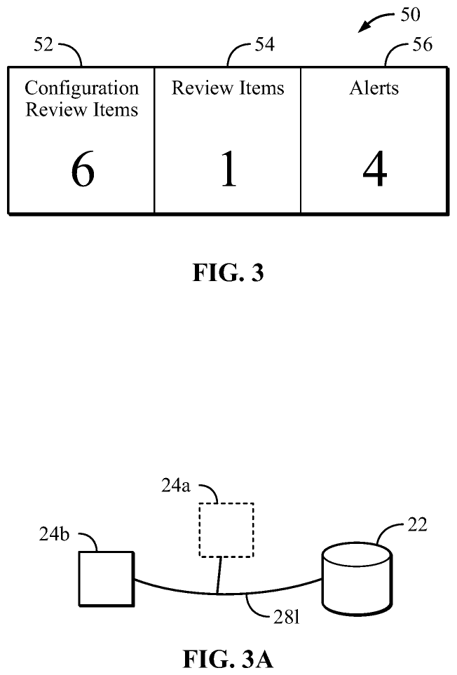

With reference next to FIG. 3, a portion of a screenshot of the monitoring application shows a dashboard 50 configured to provide a user with a summary of outstanding issues with the network security architecture. For example, a configuration review box 52 can identify a number of access events for which certain data appears inconsistent and/or missing. With additional reference to FIG. 3A, clicking on the configuration review box 52 can take the user to an access path 281 for which expected information is missing. In this example, the computer 24b from which access of the asset 22 was made is identified, but no user credential 24a has been identified. However, the access path 281 may conform within a trust zone and thus not trigger a trust zone violation. In this situation, there may be incomplete or misindexed log data, and the user may perform additional investigation to resolve the issue. A problem could be that the associated computer 24b may not be set up to collect and transmit all of the correct log data. Thus, investigation can lead to fixing the issue and making the security monitoring model more accurate and reliable. However, further investigation could also lead to identifying a breach in which a bad actor has manipulated or hidden credential information in order to gain access.

With continued reference to FIG. 3, the review items 54 box of the dashboard 50 can indicate access transactions that are not yet classified within a trust zone. The user can click upon this box to be shown such access events. The alerts box 56 refers to trust zone violations. Clicking on this box 56 can take the user to visual representations of access events that violate trust zones, such as access paths 28g, 28h, 28j and 28k of FIG. 2.

As noted above, strict zero trust architecture entails controlling access control to within micro-perimeters defined within the network 20. However, in today's computing environment access is often given to remote sources and services that are outside the network. In some embodiments remote access is attained by sources that are under the control of the organization, and thus endpoint control software may be installed on the sources even if they are remote from the network. However, in other instances, remote access to an organization's network 20 is authorized to entities that are not controlled by the organization, and thus are outside the scope of any micro-perimeter that could be included in the network architecture.

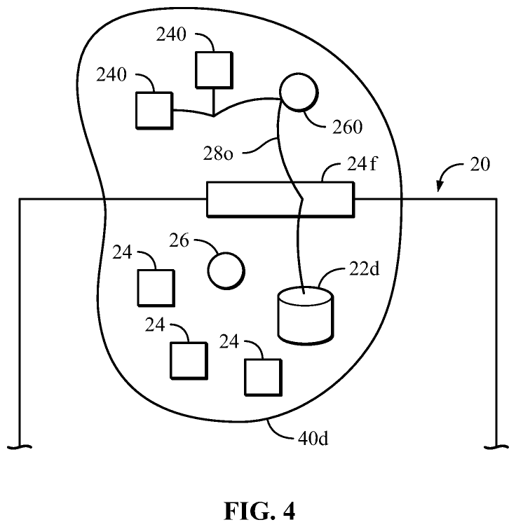

With reference next to FIG. 4, the monitoring application preferably is configured so that a trust zone 40d can be defined to include at least some elements that are outside of, and outside of the control of, the network 20. Specifically, outside sources 24o working through a service 26o such as a web protocol, can access network asset 22d via a firewall 24f. It is anticipated that the firewall 24f can obtain identifying information about the outside sources 24o and services 26o, and report such information in logs so that the monitoring application can determine access path 28o which, as shown, is fully contained within trust zone 40d, and thus will not generate a trust zone violation alert.

In addition to being able to use real-time network usage data to identify problems in its model of the network security system that can be updated and corrected, and in addition to highlighting areas of vulnerability and/or increased risk, and even in addition to detecting actual breaches, the monitoring application can use real-time network usage to identify mistakes that may create network security risks. For example, in one example instance an authorized user attempts to access the network from her home laptop computer, but is blocked from access by micron-perimeter controls. The issue is raised with IT staff, and access controls are modified to allow such access from outside the network, and also to add the laptop computer as a source in a related trust zone. However, perhaps the IT staff mistakenly opens the controls too much, so that the user's entire ISP is mistakenly granted access. At first, the network has no mechanism for highlighting this self-imposed problem, which is not consistent with the design of the network security structure. If, some time later, the same user access the network from her home desktop computer, which has not been specifically added to the trust zone, a trust zone violation alert will be generated, leading IT staff to contemplate the question of why a source outside the trust zone was, nonetheless, able to access the network through the tight controls. The previous mistake is thus more likely to be found. Also, if, instead of the user herself, any other person within the user's ISP was able to gain access, again a trust zone violation would trigger attention to the issue, leading to detection and resolution of the problem.

The monitoring application is configured as a resource for an IT user to better be able to understand and visualize access patterns of the network 20. For example, access paths 28 that are determined and identified by the monitoring application can be saved. Reports can depict frequency of use of particular access paths over time. As such, an IT user may determine that a particular source 24 is seldom used within its trust zone, and perhaps the decision to include that particular source 24 in the trust zone should be reevaluated. Minimizing the number of sources 24 within a trust zone 40, of course, reduces the risks of breach of that trust zone. Thus, identification of dormant or unnecessary elements can reduce risks. In this manner the monitoring application can analyze actual access event data to prompt iterative security improvements of the network security architecture.

Also, to reduce risks it is desirable to reduce the number of credentials that have access to particular assets. This includes IT staff credentials. The greater the number of IT staff that are granted access to particular elements, or that are included in particular trust zones, the greater the risks of breach. Thus, it is desirable that monitoring of access events and security performance of the network can be accomplished with as little IT staff access as possible. The monitoring application, itself, has no direct access or control of elements of the network 20. Instead, as discussed above, it relies on indexed log data 34 received from the STEM 30. As such, an IT staff member having substantially no credentialed access to trust zone assets 22 can nevertheless monitor the access events for such assets 22, perform investigations to determine appropriateness of trust zone violation alerts, and the like. Detailed and thorough data regarding access paths and patterns can be accumulated and analyzed by IT staff without risking the grant of access to confidential data by such IT staff.

The embodiments discussed above have disclosed structures with substantial specificity. This has provided a good context for disclosing and discussing inventive subject matter. However, it is to be understood that other embodiments may employ different specific structural configurations and interactions.

Although inventive subject matter has been disclosed in the context of certain preferred or illustrated embodiments and examples, it will be understood by those skilled in the art that the inventive subject matter extends beyond the specifically disclosed embodiments to other alternative embodiments and/or uses of the invention and obvious modifications and equivalents thereof. In addition, while a number of variations of the disclosed embodiments have been shown and described in detail, other modifications, which are within the scope of the inventive subject matter, will be readily apparent to those of skill in the art based upon this disclosure. It is also contemplated that various combinations or subcombinations of the specific features and aspects of the disclosed embodiments may be made and still fall within the scope of the inventive subject matter. Accordingly, it should be understood that various features and aspects of the disclosed embodiments can be combined with or substituted for one another in order to form varying modes of the disclosed inventive subject matter. Thus, it is intended that the scope of the inventive subject matter herein disclosed should not be limited by the particular disclosed embodiments described above, but should be determined only by a fair reading of the claims that follow.

What is claimed is:

1. A system for modeling and monitoring a network security architecture, comprising:
a monitoring application configured to receive log data from a plurality of network elements, the plurality of network elements comprising a plurality of sources, a plurality of services and a plurality of assets;
the monitoring application configured to receive input identifying a trusted group of sources that are to be authorized to access a first asset and to receive input identifying a group of at least one trusted service that is to be authorized to access the first asset;
the monitoring application configured to define a trust zone that includes the trusted group of sources, the trusted service and the first asset; and
the monitoring application configured to analyze the log data to identify an access event wherein a first source of the plurality of sources and a first service of the plurality of services accessed the first asset;
wherein the monitoring application is configured to determine whether the first source is part of the trusted group of sources and whether the first service is part of the group of at least one trusted services; and
wherein the monitoring application is configured to generate a trust zone violation alert if the first source is not part of the trusted group of sources or if the first service is not part of the group of at least one trusted services.

2. The system of claim 1, wherein the log data comprises indexed log data indexed by a security information event management system (SIEM).

3. The system of claim 2, wherein the monitoring application has no direct access to the plurality of network elements.

4. The system of claim 1, wherein the monitoring application is configured to direct a visual depiction of the trust zone showing the trusted group of sources, group of at least one trusted services, and first asset within the trust zone.

5. The system of claim 4, wherein the monitoring application is configured so that when the access event has been identified, an access path is generated visually linking the first source to the first service and the first asset.

6. The system of claim 1, wherein the monitoring application is configured to identify a second source by analyzing the log data, wherein the second source is not included in the plurality of network elements.

7. The system of claim 6, wherein the monitoring application is configured to receive an input adding the second source to the group of trusted sources.

8. A method of modeling and monitoring a network access security architecture, comprising:
identifying a plurality of network elements, the plurality of network elements comprising a plurality of sources, a plurality of services and a plurality of assets;
identifying a trusted group of the plurality of network elements, the trusted group being expected to participate with one another in authorized access events in which elements from the trusted group access a first asset;
defining a trust zone and including the trusted group of the plurality of network elements in the trust zone with the first asset;
receiving log data identifying access event data concerning the plurality of network elements;
analyzing the log data to identify an access event in which the first asset was accessed by a first source using a first service; and
determining whether the first source and first service are in the trusted group.

9. The method of claim 8, additionally comprising generating a trust zone violation alert if the first source and first service are not in the trusted group.

10. The method of claim 8, comprising generating an access path based on the log data, the access path tying the first source and the first service to the first asset.
